(19) United States
(12) Patent Application Publication
(10) Pub. No.: US 2023/0114462 A1
(43) Pub. Date: Apr. 13, 2023

(54) SELECTIVE PRESENTATION OF AN AUGMENTED REALITY ELEMENT IN AN AUGMENTED REALITY USER INTERFACE

(71) Applicant: Capital One Services, LLC, McLean, VA (US)

(72) Inventor: Zachary SKEMP, Ashburn, VA (US)

(21) Appl. No.: 17/450,777

(22) Filed: Oct. 13, 2021

(51) Int. Cl. G06Q 30/06; G06K 9/00; G06Q 30/02; G06T 19/00; G06F 16/951

(52) U.S. Cl. CPC G06Q 30/0643; G06K 9/00671; G06Q 30/0239; G06T 19/006; G06F 16/951

(57) ABSTRACT

In some implementations, a device may receive from an augmented reality (AR) device, object information identifying respective identities of a plurality of objects in an environment of the AR device. The device may select at least one object of the plurality of objects identified by the object information, and discard one or more objects of the plurality of objects identified by the object information, based on at least one of: historical data associated with a user of the AR device or comparison data that identifies amounts associated with objects in connection with at least one entity. The device may determine presentation information for the at least one object, based on the comparison data. The device may transmit, to the AR device, the presentation information for generation of an AR user interface including the AR element based on the presentation information.

### BACKGROUND

Augmented reality (AR) may refer to a live view of a physical, real-world environment that is modified by a computing device to enhance an individual's current perception of reality. In augmented reality, elements of the real-world environment are “augmented” by computer-generated or extracted input, such as sound, video, graphics, haptics, and/or global positioning system (GPS) data, among other examples. Augmented reality may be used to enhance and/or enrich the individual's experience with the real-world environment.

### SUMMARY

In some implementations, a non-transitory computer-readable medium storing a set of instructions for selective presentation of an augmented reality element includes one or more instructions that, when executed by one or more processors of an augmented reality device, cause the augmented reality device to: obtain image data associated with an environment of the augmented reality device that includes a plurality of objects; determine, based on the image data, respective identities and respective amounts associated with each of the plurality of objects; transmit, to a device, object information identifying the respective identities and the respective amounts associated with the plurality of objects; receive, from the device and based on transmitting the object information, presentation information for at least one object of the plurality of objects, where the presentation information indicates whether an amount, of the respective amounts, associated with the at least one object is a lowest amount identified for the at least one object, and where the at least one object is selected from the plurality of objects, and one or more objects of the plurality of objects are discarded, based on at least one of: historical data associated with a user of the augmented reality device, or comparison data that identifies amounts associated with objects in connection with at least one entity; generate an augmented reality user interface including the augmented reality element based on the presentation information for presentation on the augmented reality device; and cause presentation of the augmented reality user interface including the augmented reality element on the augmented reality device.

In some implementations, a system for selective presentation of an augmented reality element includes one or more memories and one or more processors, communicatively coupled to the one or more memories, configured to: receive, from an augmented reality device, object information identifying respective identities of a plurality of objects in an environment of the augmented reality device; select at least one object of the plurality of objects identified by the object information, and discard one or more objects of the plurality of objects identified by the object information, based on historical data associated with a user of the augmented reality device; determine presentation information for the at least one object, based on comparison data, where the comparison data identifies an amount associated with the at least one object in connection with at least one entity, and where the presentation information indicates the amount; and transmit, to the augmented reality device, the presentation information for generation of an augmented reality user interface including the augmented reality element based on the presentation information.

In some implementations, a method of selective presentation of an augmented reality element includes receiving, by a device, from an augmented reality device, object information identifying respective identities of a plurality of objects in an environment of the augmented reality device; selecting, by the device, at least one object of the plurality of objects identified by the object information, and discarding one or more objects of the plurality of objects identified by the object information, based on at least one of: historical data associated with a user of the augmented reality device, or comparison data that identifies amounts associated with objects in connection with at least one entity; determining, by the device, presentation information for the at least one object, based on the comparison data, where the comparison data identifies an amount associated with the at least one object in connection with the at least one entity, and where the presentation information indicates the amount; and transmitting, by the device, to the augmented reality device, the presentation information for generation of an augmented reality user interface including the augmented reality element based on the presentation information.

### BRIEF DESCRIPTION OF THE DRAWINGS

FIGS. 1A-1G are diagrams of an example implementation relating to selective presentation of an augmented reality element in an augmented reality user interface.

FIG. 2 is a diagram of an example environment in which systems and/or methods described herein may be implemented.

FIG. 3 is a diagram of example components of one or more devices of FIG. 2.

FIGS. 4-5 are flowcharts of example processes relating to selective presentation of an augmented reality element in an augmented reality user interface.

### DETAILED DESCRIPTION

The following detailed description of example implementations refers to the accompanying drawings. The same reference numbers in different drawings may identify the same or similar elements.

Augmented reality (AR) may be used to superimpose virtual elements (sometimes referred to as AR elements herein) on a display of an image of an environment that is being captured (e.g., in real time). For example, a user of a user device (e.g., a smartphone, a tablet, smart glasses, or the like) may use a camera of the user device to capture video of the user's surroundings, and the user device (e.g., executing an AR application running on the user device) may superimpose one or more AR elements on the image being captured by the user device in an AR user interface.

In some examples, the AR elements that are superimposed on the image may relate to objects that are identified in the image. For example, the objects may be items that are available for purchase, and the AR elements may provide price information for the objects, price comparison information for the objects, or the like. However, if numerous objects are identified in the image, the AR elements may overwhelm the AR user interface, which creates a poor user experience and consumes excessive computing resources (e.g., processing resources and memory resources) that are needed for the user device and/or a server device communicating with the user device to determine a content of the AR elements, generate the AR elements, and/or generate the AR user interface.

Some implementations described herein relate to selective presentation of AR elements in an AR user interface. In some implementations, an AR device may obtain image data, such as video, associated with an environment (e.g., surroundings) of the AR device that includes a plurality of objects (e.g., items available for purchase). For example, the environment may be a commercial environment associated with an entity, such as a store. Furthermore, based on the image data, the AR device may identify objects in the environment (e.g., using an image segmentation technique, an object detection technique, or the like) and/or amounts (e.g., prices) associated with the objects. The AR device may transmit object information, that identifies the objects and/or the amounts, to a selection system.

The selection system may select one or more objects identified by the AR device, and discard (e.g., not select) one or more objects identified by the AR device, based on historical transaction data or historical web browsing data associated with a user of the AR device and/or comparison data that identifies amounts (e.g., prices) associated with the objects in connection with one or more other entities. The selection system may transmit, to the AR device, presentation information for the one or more objects that is to be used by the AR device to generate AR elements. Accordingly, the AR device may generate an AR user interface that includes one or more AR elements based on the presentation information (e.g., includes AR elements for the objects selected by the selection system), but that does not include AR elements for objects discarded by the selection system.

The selectivity provided by the selection system reduces the quantity of AR elements that will need to be generated and displayed by the AR device without sacrificing the robustness of relevant information that is conveyed by the AR elements. In this way, computing resources may be conserved by reducing an amount of AR elements that are generated for the AR user interface. Furthermore, the selectivity provided by the selection system enhances the AR user interface, thereby improving a user experience, enhancing user-friendliness of an AR device and the AR user interface, and improving the ability of a user to use the AR device.

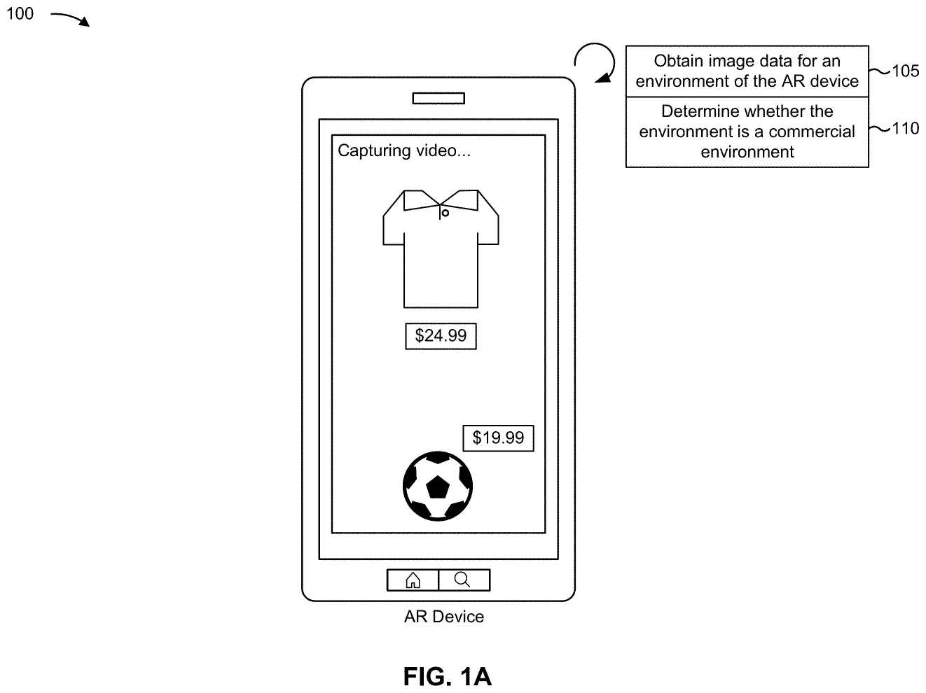

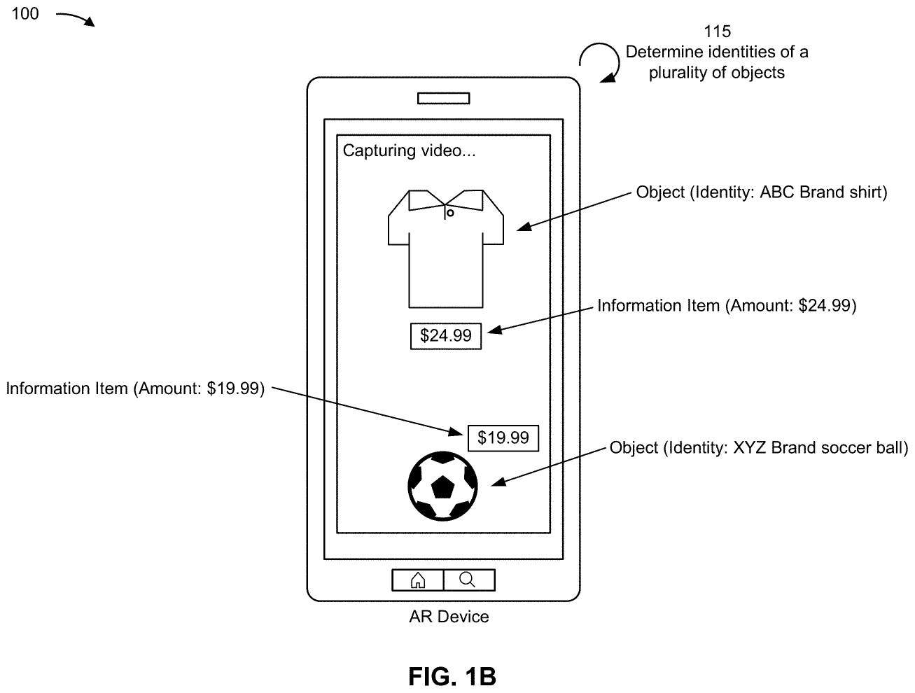

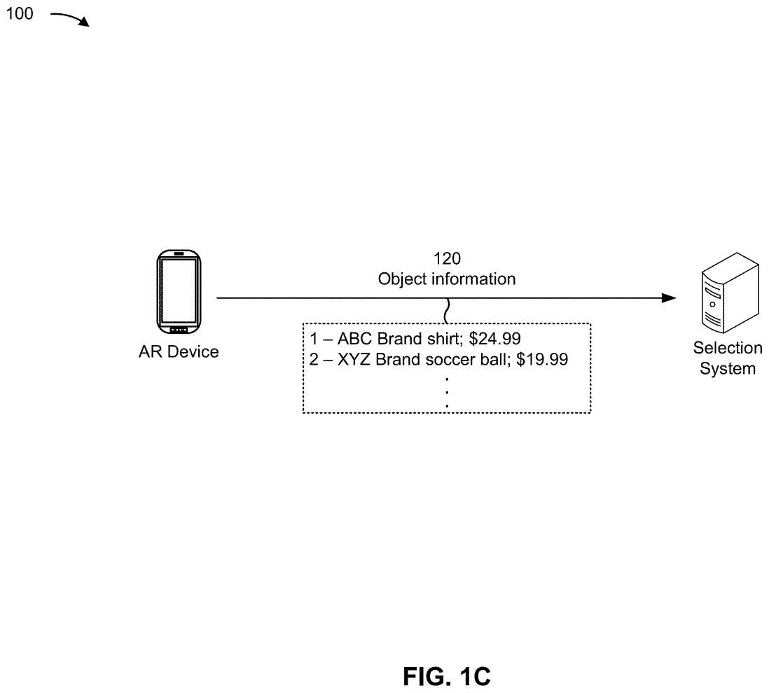

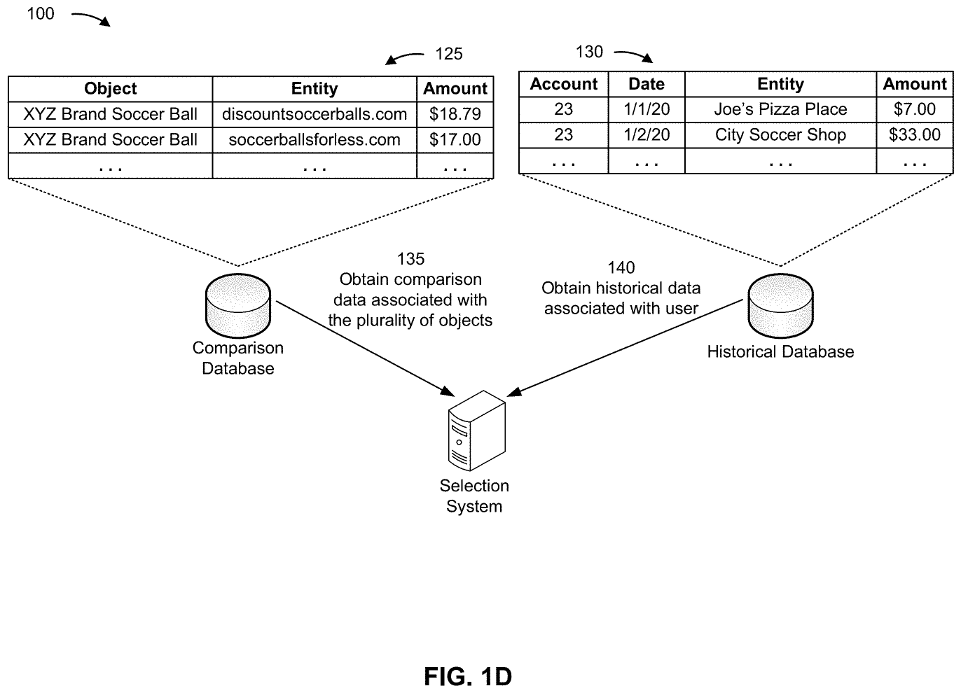

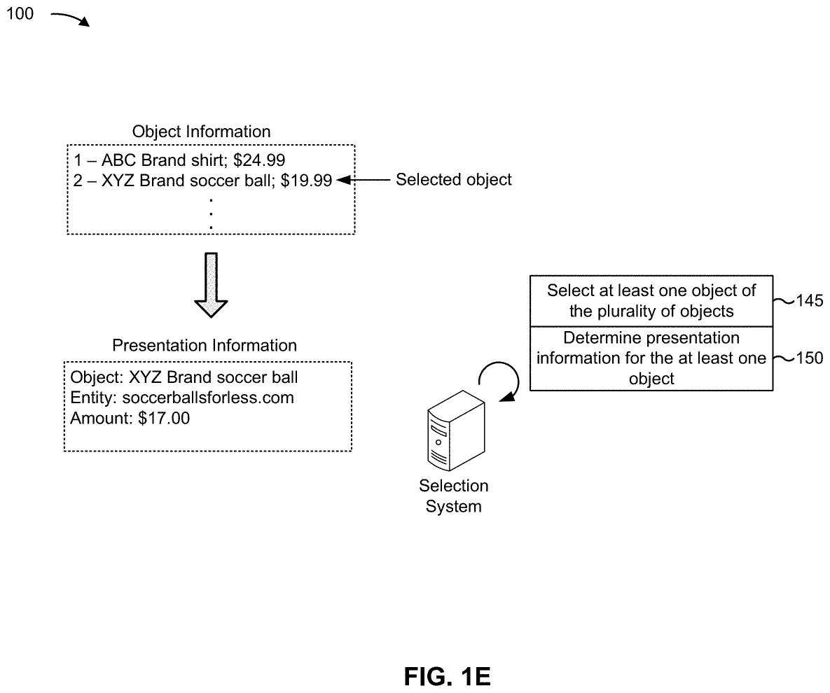

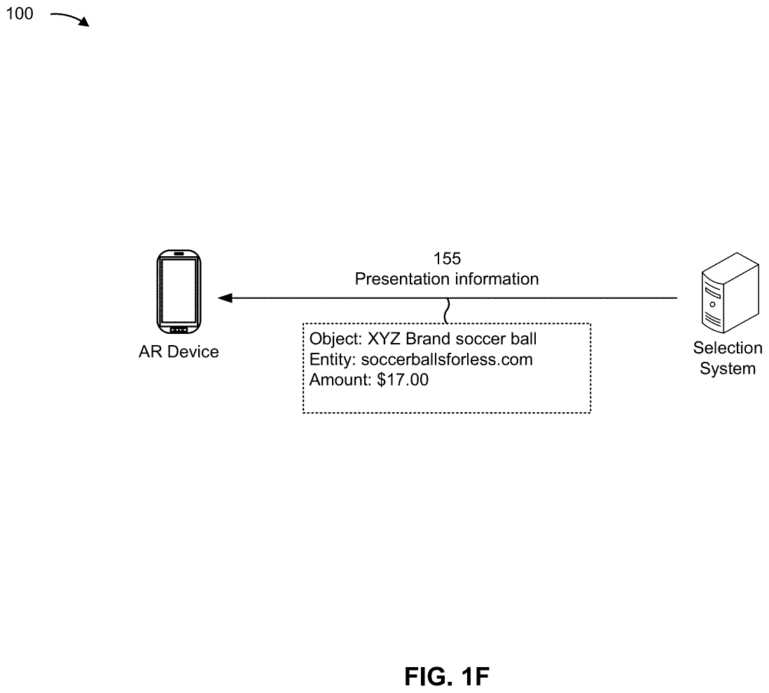

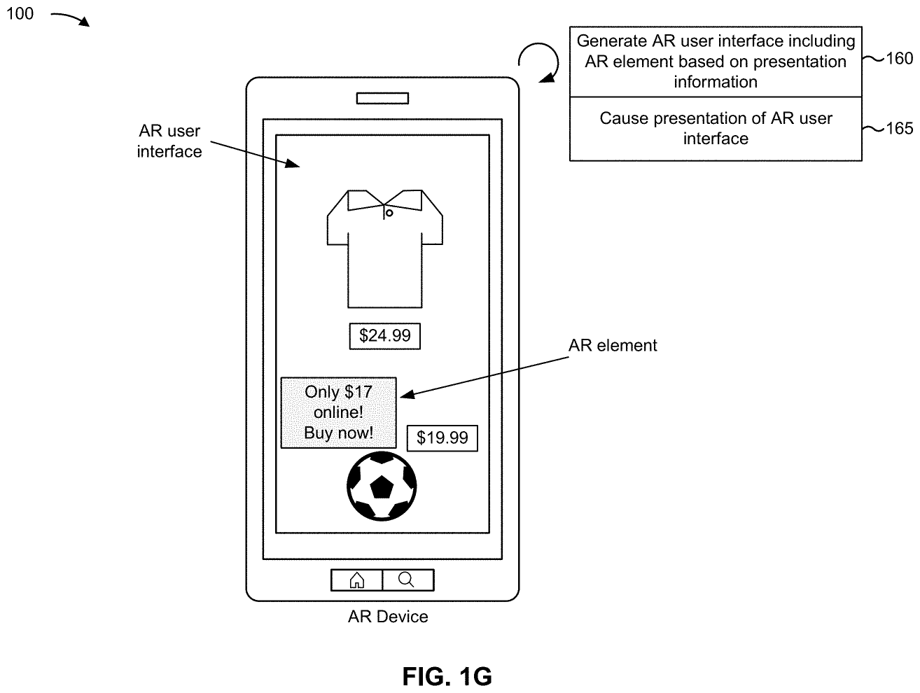

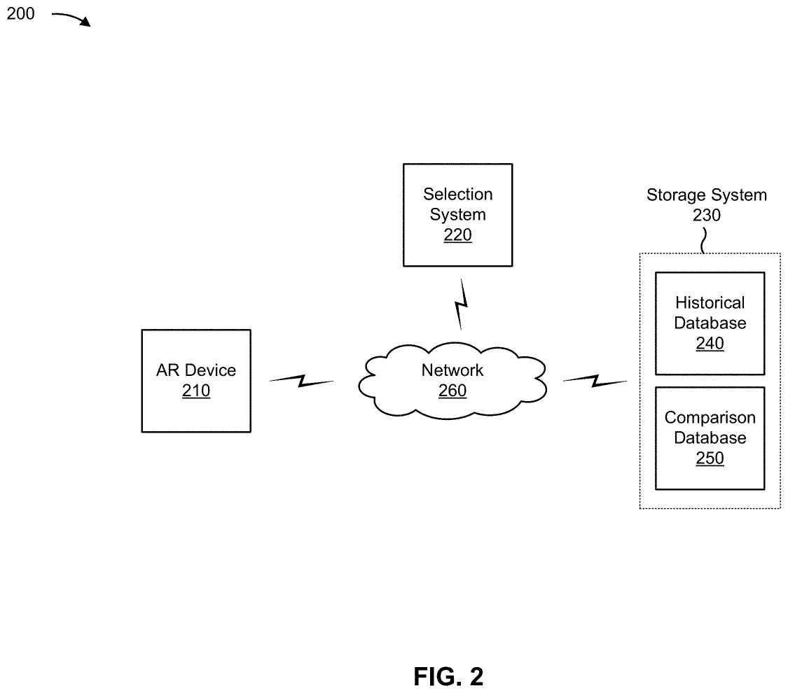

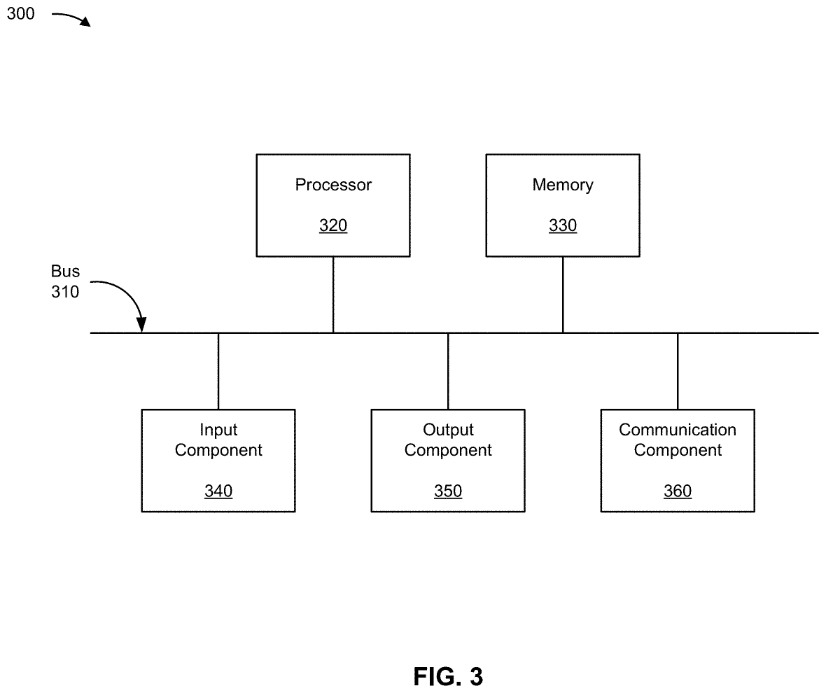

FIGS. 1A-1G are diagrams of an example 100 associated with selective presentation of an AR element in an AR user interface. As shown in FIGS. 1A-1G, example 100 includes an AR device, a selection system, and a plurality of databases (e.g., a historical database and/or a comparison database, which may be included in a storage system). These devices are described in more detail in connection with FIGS. 2 and 3. The AR device may be associated with a user that is operating and/or wearing the AR device. The AR device and/or the selection system may perform operations associated with selective presentation of an AR element, as described below.

As shown in FIG. 1A, and by reference number 105, the AR device may obtain image data associated with an environment (e.g., surroundings) of the AR device. For example, the AR device may be present in a commercial environment, such as a store, a shopping center, a shopping district, or the like. The environment may include a plurality of objects (e.g., items available for purchase). For example, the plurality of objects may be arranged on shelves, racks, or the like, and respective information items (e.g., a price tag, a price display, a sign, or the like) associated with the plurality of objects may be included in the environment located in proximity to the plurality of objects.

In some implementations, the image data may include one or more images (e.g., image frames of a video) and/or one or more videos. In some implementations, the AR device may obtain the image data based on an event indicating that the AR device is to present an AR user interface. For example, the event may be the user providing a voice command to the AR device, the user pressing a button of the AR device, the user launching an AR application on the AR device, or the like.

As shown by reference number 110, the AR device may determine whether the environment of the AR device is a commercial environment (e.g., a store, a shopping center, or the like). The AR device may determine whether the environment is a commercial environment based on the image data. For example, the AR device may process the image data using a machine learning technique (e.g., a neural network technique) to determine whether the environment is a commercial environment. Additionally, or alternatively, the AR device may receive a signal (e.g., a Bluetooth signal or another near field communication signal) from a transaction terminal in the environment, and the AR device may determine, based on the signal, that the environment is a commercial environment. For example, the signal may identify a transaction terminal and/or a merchant, which may enable the AR device to infer that the environment is a commercial environment. If the environment is not a commercial environment, the AR device may refrain from performing one or more of the operations described below.

As shown in FIG. 1B, and by reference number 115, the AR device may determine respective identities associated with each of the plurality of objects. An identity of an object may include a category of the object, a type of the object, and/or a manufacturer (e.g., a brand) of the object. In addition, the AR device may determine respective amounts (e.g., prices) associated with each of the plurality of objects. For example, the AR device may determine an amount associated with an object based on an information item associated with the object.

The AR device may determine the identities and/or the amounts based on the image data. For example, to identify the objects and/or the information items in the image data, the AR device may process the image data using a computer vision technique, an image segmentation technique (e.g., using an image segmentation algorithm), an object detection technique (e.g., using an object detection algorithm), a machine learning technique (e.g., a neural network technique), a template matching technique, or the like. Furthermore, to identify the amounts (e.g., prices) associated with the objects based on the information items, the AR device may process the image data (e.g., regions of the image data associated with the information items) using an optical character recognition (OCR) technique, a natural language processing technique (NLP), or the like.

In some implementations, the AR device may identify the amounts associated with the objects from the image data, and the AR device may determine associations between the amounts and the plurality of objects. In other words, identification of the amounts from the image data may not indicate which amounts are associated with which objects, and the AR device may determine the associations between the amounts and the plurality of objects. For example, the AR device may determine that an amount is associated with an object if an information item (e.g., that indicates the amount) is within a threshold distance of the object and/or if the information item has a particular position relative to the object (e.g., above the object or below the object). As another example, the AR device may determine that an amount is associated with an object based on additional information included in the information item. For example, the AR device may determine that a product identifier (e.g., a universal product code (UPC)) included in the information item corresponds to the object, that a description included in the information item corresponds to the object, or the like.

As an example, as shown, the AR device may identify the plurality of objects as an “ABC brand shirt” and an “XYZ brand soccer ball” using the image data. Moreover, the AR device may determine that the information item indicating an amount of $24.99 is associated with the shirt and the information item indicating an amount of $19.99 is associated with the soccer ball. In some implementations, the AR device may transmit the image data to the selection system, or another device, to enable the selection system or the other device to identify the objects, the amounts, whether the environment is a commercial environment, or the like.

As shown in FIG. 1C, and by reference number 120, the AR device may transmit, and the selection system may receive, object information that identifies the respective identities (e.g., “ABC brand shirt” and “XYZ brand soccer ball,” as shown) and/or the respective amounts (e.g., $24.99 and $19.99, as shown) associated with the plurality of objects. For example, the object information may identify the respective identities associated with the plurality of objects by object identifiers (e.g., that map to the objects), by descriptions, by tags, or the like. In some implementations, an identity of an object identified by the object information may include a generic identifier of the object (e.g., “shirt”), a source of the object (e.g., “ABC brand”), a model code or item code associated with the object, and/or a product identifier (e.g., a UPC) associated with the object. In some implementations, the object information may identify only the identities of the plurality of objects, and the selection system may determine the amounts associated with the objects, as described below.

In some implementations, the object information also may identify the entity associated with the environment of the AR device (which may be referred to herein as the “current entity”). In some implementations, the user may provide an input to the AR device that identifies the current entity. Additionally, or alternatively, the AR device may determine the current entity (e.g., automatically, without an input from the user). For example, the AR device may determine the current entity by processing the image data, in a similar manner as described above. That is, the image data may depict one or more signs, information items, or the like, that display the name of the current entity, and the AR device may extract the name of the current entity from the image data based on processing the image data. The AR device may determine that the name corresponds to the current entity (rather than corresponding to a product, an aisle description, etc.) based on a size of text associated with the name (e.g., the name of the current entity may be displayed in larger text relative to text used for displaying product names, aisle descriptions, etc.). Additionally, or alternatively, the AR device may determine that the name corresponds to the current entity by referencing the name against a list of entities (e.g., a business directory). As another example, the AR device may determine the current entity based on a location of the AR device. That is, the AR device may use location data of the AR device to identify a geographic location of the AR device, and the AR device may identify the entity associated with the geographic location of the AR device (e.g., using map data, address data, or the like).

In some implementations, the selection system may determine the entity associated with the environment of the AR device (e.g., if such information is not indicated by the object information). For example, the selection system may receive the image data from the AR device, and the selection system may extract the name of the current entity from the image data based on processing the image data, in a similar manner as described above. The selection system may determine that the name corresponds to the current entity in a similar manner as described above. For example, the selection system may determine that the name corresponds to the current entity by referencing the name against a list of entities associated with historical transaction events (e.g., identified by historical data 130, as described below). As another example, the selection system may receive location data from the AR device, and the selection system may identify the entity associated with the geographic location of the AR device, in a similar manner as described above.

As shown in FIG. 1D, the comparison database may store comparison data 125. The comparison data 125 may identify amounts associated with objects in connection with a plurality of entities (e.g., a plurality of merchants). The comparison data 125 may include one or more entries, and an entry may identify an object, an entity (e.g., a merchant) that offers the object (e.g., for purchase), and/or an amount (e.g., a price) at which the entity offers the object. The comparison data 125 may include multiple entries for the same object, each entry being associated with a different entity. For example, as shown, the comparison data 125 may indicate amounts of the “XYZ brand soccer ball” in connection with a first entity “discountsoccerballs.com” and a second entity “soccerballsforless.com.” In some implementations, the amounts identified by the comparison data 125 may be based on information determined (e.g., scraped) from one or more web pages (e.g., pricing information for items may be scraped from web pages associated with one or more entities) and/or historical transaction data associated with a plurality of users (e.g., the historical transaction data may indicate prices paid for items by the plurality of users at one or more entities). In this way, the comparison data 125 provides comparison pricing information for various goods at various merchants.

As also shown in FIG. 1D, the historical database may store historical data 130. The historical data 130 may include one or more entries respectively associated with one or more historical transaction events. The historical transaction events may be associated with a plurality of accounts (e.g., associated with a plurality of users, such as the user of the AR device). An entry for a historical transaction event may identify an account (e.g., a financial account, a transaction card account, a checking account, or the like) associated with the transaction event, a date when the transaction event occurred, an entity (e.g., a merchant) associated with the transaction event, and/or an amount of the transaction event. In some implementations, the entry may further identify one or more objects (e.g., items) involved in the transaction event. For example, as shown, for an account associated with the user (account 23, as shown), the historical data 130 may indicate a transaction event in connection with “Joe's Pizza Place” and a transaction event in connection with “City Soccer Shop.”

Additionally, or alternatively, the historical data 130 may include historical web browsing data (not shown). The historical web browsing data may include one or more entries respectively associated with one or more historical web browsing events. The historical web browsing events may be associated with a plurality of users, such as the user of the AR device. An entry for a historical web browsing event may identify a user associated with the web browsing event, a date when the web browsing event occurred, a web domain associated with the web browsing event, an entity (e.g., a merchant) associated with the web domain, a web page associated with the web browsing event, and/or an object associated with the web page (e.g., an item offered for sale via the web page).

As shown by reference number 135, the selection system may obtain comparison data associated with the plurality of objects identified by the object information. That is, the selection system may obtain the comparison data from the comparison database. The comparison data that is obtained may identify one or more amounts associated with one or more of the plurality of objects in connection with at least one entity. The at least one entity may not be an entity that is associated with the environment of the AR device (e.g., the at least one entity is not the current entity). For example, if the AR device is present in a store associated with the current entity, the comparison data that is obtained may relate to one or more different entities.

In some implementations, the selection system may obtain, from the comparison database, information that identifies an amount associated with one or more of the plurality of objects identified by the object information. That is, if the object information identifies only the identities of one or more of the plurality of objects (e.g., the object information does not identify amounts for one or more of the plurality of objects), then the selection system may determine, using the comparison data 125, respective amounts associated with one or more of the plurality of objects based on the identities of the objects and the current entity.

As shown by reference number 140, the selection system may obtain historical data associated with the user of the AR device. That is, the selection system may obtain the historical data from the historical database. As described above, the historical data may include historical transaction data associated with the user and/or historical web browsing data associated with the user.

As shown in FIG. 1E, and by reference number 145, the selection system may select at least one object of the plurality of objects identified by the object information. When selecting the at least one object, the selection system may discard (e.g., not select) one or more objects of the plurality of objects. In other words, less than all of the plurality of objects identified by the object information may be selected by the selection system.

The selection system may select the at least one object, and discard the one or more objects, based on the comparison data obtained by the selection system and/or the historical data obtained by the selection system. To select or discard an object based on the comparison data, the selection system may determine whether a difference between an amount associated with the object identified by the comparison data (e.g., a price of the object offered by another entity), and an amount associated with the object identified by the object information or determined by the selection system based on the comparison data 125 (e.g., a price of the object offered by the current entity), satisfies a threshold. The selection system may select the object if the difference satisfies the threshold, and the selection system may discard the object if the different does not satisfy the threshold. In this way, the object is discarded if the difference of the amounts is not sufficiently large enough to justify displaying an AR element for the object, thereby reducing the quantity of objects for which AR elements are to be displayed. For example, as shown, the selection system may select the soccer ball because the difference between an amount associated with the soccer ball identified by the comparison data (e.g., $17.00 at soccerballsforless.com), and an amount associated with the soccer ball identified by the object information or determined by the selection system based on the comparison data 125 (e.g., $19.99), satisfies a threshold (e.g., $1, $2, or the like).

To select or discard an object based on the historical data, the selection system may determine whether the object is relevant to the user. For example, the selection system may determine whether the object is relevant to the user based on at least one historical transaction of the historical data (e.g., based on an object and/or an entity associated with the at least one historical transaction). For example, the selection system may determine that the object is relevant to the user if the object associated with the historical transaction is the same as or related to the object and/or if the entity associated with the historical transaction offers goods that are the same as or related to the object (e.g., which may be determined by the selection system based on a name of the entity and/or a category associated with the entity). As an example, as shown, the selection system may determine that the soccer ball is relevant to the user because the user is associated with a historical transaction for “City Soccer Shop.”

Additionally, or alternatively, the selection system may determine whether the object is relevant to the user based on a historical web browsing event. For example, the selection system may determine that the object is relevant to the user if the object (e.g., the soccer ball) is related to a web domain (e.g., “buysoccerballs.com”) associated with the web browsing event (e.g., the web domain includes a term associated with the object), is related to an entity (e.g., “Buy Soccer Balls, LLC”) associated with the web domain (e.g., the entity's name includes a term associated with the object and/or a category associated with the entity is related to the object), is related to a web page (e.g., “buysoccerballs.com/xyzbrandsoccerball”) associated with the web browsing event (e.g., an address of the web page includes a term associated with the object), and/or is the same as or similar to an object associated with the web page.

The selection system may select the object based on a determination that the object is relevant to the user, and the selection system may discard the object based on a determination that the object is not relevant to the user. In some implementations, the selection system may use one or more machine learning models to determine whether an object is relevant to the user. For example, the selection system may use a machine learning model trained to output an indication of whether an object is relevant to a user. The machine learning model may be trained using the historical data 130.

As shown by reference number 150, the selection system may determine presentation information for the at least one object that is selected. The presentation information that is determined may be for generation of an AR user interface that includes an AR element that is based on the presentation information. In other words, the presentation information may include information that is used for an AR element of an AR user interface that is to be generated by the AR device.

The selection system may determine the presentation information based on the comparison data obtained by the selection system. For example, the comparison data may identify an amount (e.g., a price) associated with an object in connection with the at least one other entity (e.g., other than the current entity), and the presentation information may identify the amount. Moreover, the presentation information may indicate (e.g., expressly, or implicitly by indicating a lower amount) whether an amount (e.g., a price) associated with the object in connection with the current entity is a lowest amount among all amounts that are identified for the object from the comparison data (e.g., the presentation information may indicate whether the current entity offers the best deal for the object). If the amount associated with the current entity is not the lowest amount, then the presentation information may identify, for the object, the entity associated with the lowest amount (e.g., the entity that offers the object for the lowest amount). In some implementations, the presentation information may not include information, as described above, for the one or more objects that were discarded by the selection system.

As shown in FIG. 1F, and by reference number 155, the selection system may transmit, and the AR device may receive, the presentation information. As described above, the presentation information may identify, for an object selected by the selection system, whether an amount associated with the object in connection with the current entity is a lowest amount, the lowest amount associated with the object, and/or the entity offering the lowest amount. As an example, as shown, the presentation information may identify that the entity “soccerballsforless.com” offers the soccer ball for the amount of $17.00 (e.g., thereby indicating that the amount associated with the object in connection with the current entity is not the lowest amount).

In some implementations, the presentation information may include information for presentation of an AR element that enables a discount for an exchange (e.g., a transaction) associated with an object selected by the selection platform. For example, the presentation information may include image data for a coupon, a discount code, or the like, which may be used by the AR device to generate the AR element that enables the discount. In some examples, the selection system may select the object, as described above, based on a determination that a discount is available for the object. In some implementations, the presentation information includes information for presentation of an AR element that enables an exchange (e.g., a transaction) associated with an object. For example, the presentation information may include hyperlink information for generating a hyperlink to a webpage from which a transaction for the object may be executed (e.g., with the entity associated with the lowest amount for the object). As another example, the presentation information may include input information for generating an input element (e.g., a button) that enables execution of a transaction for the object (e.g., with the entity associated with the lowest amount for the object).

As shown in FIG. 1G, and by reference number 160, the AR device may generate an AR user interface, for presentation on the AR device, that includes one or more AR elements that are based on the presentation information. In some implementations, the AR device may generate the AR user interface to include a respective AR element, based on the presentation information, for each object selected by the selection system. Accordingly, the AR user interface that is generated may not include AR elements for the one or more objects that are discarded by the selection system, thereby conserving computing resources (e.g., associated with generating additional AR elements) and improving the AR user interface.

An AR element may include information indicating whether an amount associated with an object in connection with the current entity is the lowest amount. Additionally, or alternatively, the AR element may include information indicating the lowest amount and/or indicating an entity offering the object for the lowest amount. In some implementations, the AR element may include information (e.g., a digital coupon, a discount code, or the like) that enables the user of the AR device to receive a discount on the object (e.g., from the current entity or another entity). In some implementations, the AR element may include an input element (e.g., a button, a hyperlink, or the like) that enables an exchange associated with the object (e.g., the user may purchase the object via the input element).

In some examples, the AR user interface may include video or an image captured by the AR device overlaid with one or more AR elements (e.g., graphical elements). As another example, the AR user interface may include one or more AR elements (e.g., graphical elements) projected on a transparent display. As shown by reference number 165, the AR device may cause presentation of the AR user interface, that includes the AR elements, on the AR device.

As indicated above, FIGS. 1A-1G are provided as an example. Other examples may differ from what is described with regard to FIGS. 1A-1G.

FIG. 2 is a diagram of an example environment 200 in which systems and/or methods described herein may be implemented. As shown in FIG. 2, environment 200 may include an AR device 210, a selection system 220, a storage system 230 (e.g., that includes a historical database 240 and/or a comparison database 250), and a network 260. Devices of environment 200 may interconnect via wired connections, wireless connections, or a combination of wired and wireless connections.

The AR device 210 includes one or more devices capable of receiving, generating, storing, processing, and/or providing information associated with selective presentation of an AR element in an AR user interface, as described elsewhere herein. The AR device 210 may include a communication device and/or a computing device. For example, the AR device 210 may include a wireless communication device, a mobile phone, a user equipment, a laptop computer, a tablet computer, a gaming console, a wearable communication device (e.g., a smart wristwatch, a pair of smart eyeglasses, a head mounted display, or an AR headset), or a similar type of device.

The selection system 220 includes one or more devices capable of receiving, generating, storing, processing, providing, and/or routing information associated with selective presentation of an AR element in an AR user interface, as described elsewhere herein. The selection system 220 may include a communication device and/or a computing device. For example, the selection system 220 may include a server, such as an application server, a client server, a web server, a database server, a host server, a proxy server, a virtual server (e.g., executing on computing hardware), or a server in a cloud computing system. In some implementations, the selection system 220 includes computing hardware used in a cloud computing environment.

The storage system 230 includes one or more devices capable of receiving, generating, storing, processing, and/or providing information associated with selective presentation of an AR element in an AR user interface, as described elsewhere herein. The storage system 230 may include a communication device and/or a computing device. For example, the storage system 230 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. In some implementations, the storage system 230 may include the historical database 240 and/or the comparison database 250. The storage system 230 may communicate with one or more other devices of environment 200, as described elsewhere herein.

The network 260 includes one or more wired and/or wireless networks. For example, the network 260 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 260 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to AR device 210, selection system 220, and/or storage system 230. In some implementations, AR device 210, selection system 220, and/or storage system 230 may include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

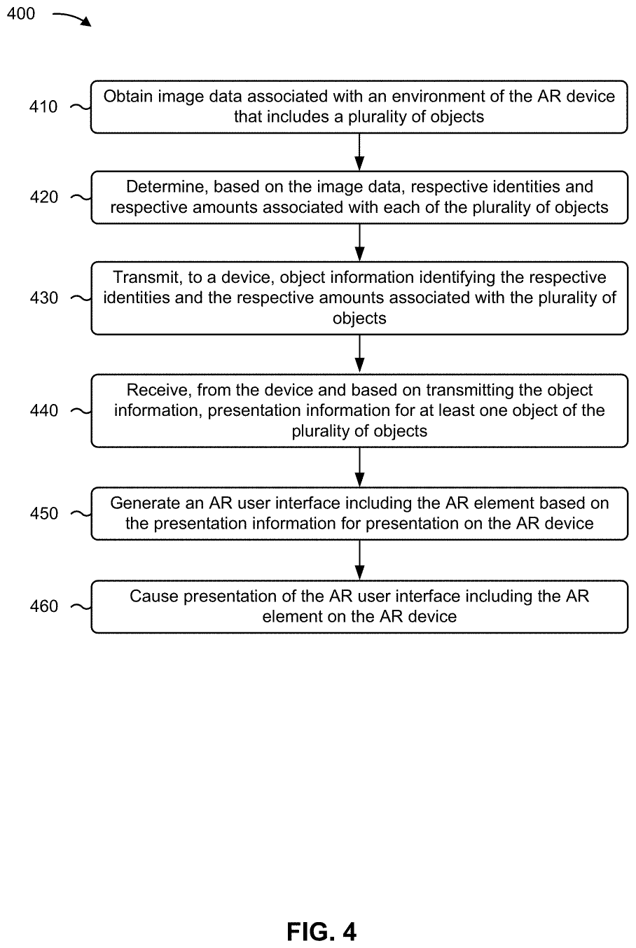

FIG. 4 is a flowchart of an example process 400 associated with selective presentation of an AR element in an AR user interface. In some implementations, one or more process blocks of FIG. 4 may be performed by an AR device (e.g., AR device 210). In some implementations, one or more process blocks of FIG. 4 may be performed by another device or a group of devices separate from or including the AR device, such as selection system 220 and/or storage system 230. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include obtaining image data associated with an environment of the AR device that includes a plurality of objects (block 410). As further shown in FIG. 4, process 400 may include determining, based on the image data, respective identities and respective amounts associated with each of the plurality of objects (block 420). As further shown in FIG. 4, process 400 may include transmitting, to a device, object information identifying the respective identities and the respective amounts associated with the plurality of objects (block 430). As further shown in FIG. 4, process 400 may include receiving, from the device and based on transmitting the object information, presentation information for at least one object of the plurality of objects (block 440). In some implementations, the presentation information indicates whether an amount, of the respective amounts, associated with the at least one object is a lowest amount identified for the at least one object. In some implementations, the at least one object is selected from the plurality of objects, and one or more objects of the plurality of objects are discarded, based on at least one of: historical data associated with a user of the AR device, or comparison data that identifies amounts associated with objects in connection with at least one entity. As further shown in FIG. 4, process 400 may include generating an AR user interface including an AR element based on the presentation information for presentation on the AR device (block 450). As further shown in FIG. 4, process 400 may include causing presentation of the AR user interface including the AR element on the AR device (block 460).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

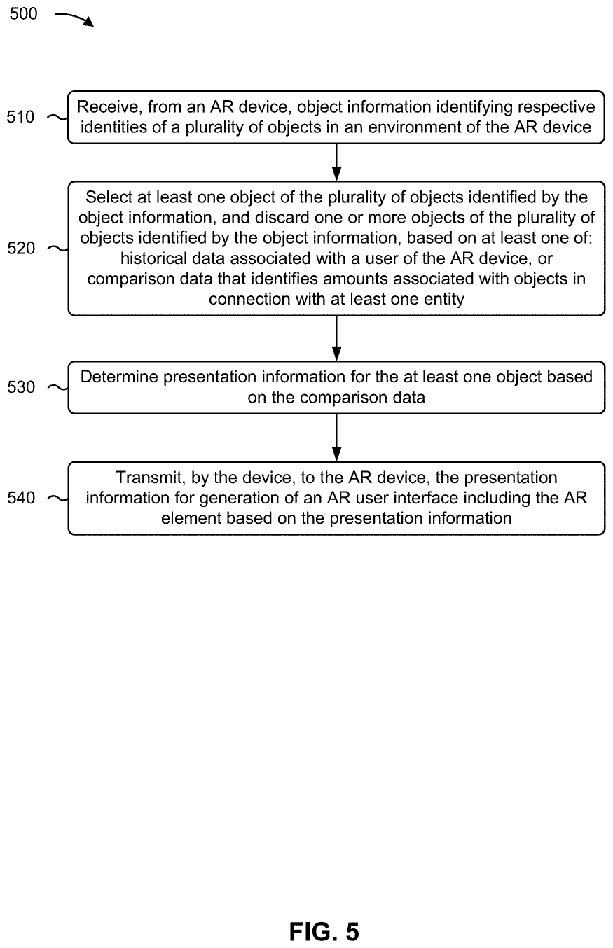

FIG. 5 is a flowchart of an example process 500 associated with selective presentation of an AR element in an AR user interface. In some implementations, one or more process blocks of FIG. 5 may be performed by a device (e.g., a device of selection system 220). In some implementations, one or more process blocks of FIG. 5 may be performed by another device or a group of devices separate from or including the device, such as AR device 210 and/or storage system 230. Additionally, or alternatively, one or more process blocks of FIG. 5 may be performed by one or more components of device 300, such as processor 320, memory 330, input component 340, output component 350, and/or communication component 360.

As shown in FIG. 5, process 500 may include receiving from an AR device, object information identifying respective identities of a plurality of objects in an environment of the AR device (block 510). As further shown in FIG. 5, process 500 may include selecting at least one object of the plurality of objects identified by the object information and discarding one or more objects of the plurality of objects identified by the object information, based on at least one of: historical data associated with a user of the AR device, or comparison data that identifies amounts associated with objects in connection with at least one entity (block 520). As further shown in FIG. 5, process 500 may include determining presentation information for the at least one object based on the comparison data (block 530). In some implementations, the comparison data identifies an amount associated with the at least one object in connection with the at least one entity. In some implementations, the presentation information indicates the amount. As further shown in FIG. 5, process 500 may include transmitting to the AR device, the presentation information for generation of an AR user interface including the AR element based on the presentation information (block 540).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A non-transitory computer-readable medium storing a set of instructions for selective presentation of an augmented reality element, the set of instructions comprising:
one or more instructions that, when executed by one or more processors of an augmented reality device, cause the augmented reality device to:
obtain image data associated with an environment of the augmented reality device that includes a plurality of objects;
determine, based on the image data, respective identities and respective amounts associated with each of the plurality of objects;
transmit, to a device, object information identifying the respective identities and the respective amounts associated with the plurality of objects;
receive, from the device and based on transmitting the object information, presentation information for at least one object of the plurality of objects,
wherein the presentation information indicates whether an amount, of the respective amounts, associated with the at least one object is a lowest amount identified for the at least one object, and
wherein the at least one object is selected from the plurality of objects, and one or more objects of the plurality of objects are discarded, based on at least one of:
historical data associated with a user of the augmented reality device, or
comparison data that identifies amounts associated with objects in connection with at least one entity;
generate an augmented reality user interface including the augmented reality element based on the presentation information for presentation on the augmented reality device; and
cause presentation of the augmented reality user interface including the augmented reality element on the augmented reality device.

2. The non-transitory computer-readable medium of claim 1, wherein the one or more instructions, when executed by the one or more processors, further cause the device to:
determine, based on the image data, that the environment of the augmented reality device is a commercial environment.

3. The non-transitory computer-readable medium of claim 1, wherein the one or more instructions, when executed by the one or more processors, further cause the device to:
receive a signal from a transaction terminal in the environment of the augmented reality device; and
determine, based on the signal, that the environment of the augmented reality device is a commercial environment.

4. The non-transitory computer-readable medium of claim 1, wherein the image data includes at least one of one or more images or one or more videos.

5. The non-transitory computer-readable medium of claim 1, wherein the augmented reality element includes one or more of:
information indicating whether the amount associated with the at least one object is the lowest amount,
information indicating the lowest amount, or
an input element that enables an exchange associated with the at least one object.

6. The non-transitory computer-readable medium of claim 1, wherein the one or more instructions, when executed by the one or more processors, further cause the device to:
identify the respective amounts from the image data; and
determine associations between the respective amounts and the plurality of objects.

7. The non-transitory computer-readable medium of claim 1, wherein the presentation information further identifies, for the at least one object, an entity associated with the lowest amount.

8. The non-transitory computer-readable medium of claim 1, wherein the augmented reality user interface that is generated does not include a different augmented reality element for the one or more objects that are discarded.

9. A system for selective presentation of an augmented reality element, the system comprising:
one or more memories; and
one or more processors, communicatively coupled to the one or more memories, configured to:
receive, from an augmented reality device, object information identifying respective identities of a plurality of objects in an environment of the augmented reality device;
select at least one object of the plurality of objects identified by the object information, and discard one or more objects of the plurality of objects identified by the object information, based on historical data associated with a user of the augmented reality device;
determine presentation information for the at least one object, based on comparison data,
wherein the comparison data identifies an amount associated with the at least one object in connection with at least one entity, and
wherein the presentation information indicates the amount; and
transmit, to the augmented reality device, the presentation information for generation of an augmented reality user interface including the augmented reality element based on the presentation information.

10. The system of claim 9, wherein the historical data identifies one or more of:
historical transaction data associated with the user, or
historical web browsing data associated with the user.

11. The system of claim 9, wherein the comparison data identifies amounts associated with objects in connection with a plurality of entities.

12. The system of claim 9, wherein the at least one entity is not an entity associated with the environment of the augmented reality device.

13. The system of claim 9, wherein the one or more processors, to select the at least one object, and discard the one or more objects, based on the historical data, are configured to:
determine, based on at least one of an object or an entity associated with at least one historical transaction of the historical data, that the at least one object is relevant to the user; and
select the at least one object, and discard the one or more objects, based on determining that the at least one object is relevant to the user.

14. The system of claim 9, wherein the presentation information includes information for presentation of the augmented reality element that enables a discount for an exchange associated with the at least one object.

15. A method of selective presentation of an augmented reality element, comprising:
receiving, by a device, from an augmented reality device, object information identifying respective identities of a plurality of objects in an environment of the augmented reality device;
selecting, by the device, at least one object of the plurality of objects identified by the object information, and discarding one or more objects of the plurality of objects identified by the object information, based on at least one of:
historical data associated with a user of the augmented reality device, or
comparison data that identifies amounts associated with objects in connection with at least one entity;
determining, by the device, presentation information for the at least one object, based on the comparison data,
wherein the comparison data identifies an amount associated with the at least one object in connection with the at least one entity, and
wherein the presentation information indicates the amount; and
transmitting, by the device, to the augmented reality device, the presentation information for generation of an augmented reality user interface including the augmented reality element based on the presentation information.

16. The method of claim 15, wherein selecting the at least one object, and discarding the one or more objects, based on the historical data comprises:
determining, based on at least one of an object or an entity associated with at least one historical transaction of the historical data, that the at least one object is relevant to the user; and
selecting the at least one object, and discarding the one or more objects, based on determining that the at least one object is relevant to the user.

17. The method of claim 15, wherein the object information further identifies respective amounts associated with the plurality of objects, and
wherein selecting the at least one object, and discarding the one or more objects, based on the comparison data comprises:
determining that a difference between the amount associated with the at least one object identified by the comparison data and an amount, of the respective amounts, associated with the at least one object satisfies a threshold; and
selecting the at least one object, and discarding the one or more objects, based on determining that the difference satisfies the threshold.

18. The method of claim 15, wherein the presentation information includes information for presentation of the augmented reality element that enables an exchange associated with the at least one object.

19. The method of claim 15, further comprising:
determining, using the comparison data, respective amounts associated with the plurality of objects, based on the respective identities associated with the plurality of objects and an entity associated with the environment of the augmented reality device.

20. The method of claim 15, wherein the amounts identified by the comparison data are based on at least one of information scraped from one or more web pages or historical transaction data associated with a plurality of users.
